(19) United States
(12) Patent Application Publication
(10) Pub. No.: US 2019/0250930 A1
(43) Pub. Date: Aug. 15, 2019

(54) METHOD AND APPARATUS FOR CONFIGURING A SERIAL DATA LINK

(71) Applicant: Western Digital Technologies, Inc., san Jose, CA (US)

(72) Inventor: Eran Erez, Bothell, WA (US)

(21) Appl. No.: 15/894,795

(22) Filed: Feb. 12, 2018

(51) Int. Cl. G06F 9/445; G06F 1/32; G06F 13/42

(52) U.S. Cl. CPC G06F 9/44505; G06F 2213/0026; G06F 13/4282; G06F 1/3296

(57) ABSTRACT

Aspects of the present disclosure provide systems and methods for dynamic serial data link (e.g., Peripheral Component Interconnect Express) reconfiguration to optimize power consumption of the serial data link. In some embodiments, Peripheral Component Interconnect Express (PCIe) link reconfiguration may be based on power state based transition, utilization based transition, and/or host based transition.

### FIELD

Aspects of the disclosure relate generally to data communication, and more specifically, to dynamic serial data link configuration.

### BACKGROUND

A Peripheral Component Interconnect (PCI) bus is a common connection interface for attaching computer peripherals to a host computer. Early versions of PCI use a parallel bus to connect the peripherals with the computer. Some examples of PCI peripherals are data storage systems, network cards, USB hubs, graphic cards, etc. A Peripheral Component Interconnect Express (PCI-Express or PCIe) is a modification of the standard PCI bus. The PCIe uses a high speed serial point-to-point communication link instead of a parallel bus. More detail on PCIe can be found, for example, in PCI Express® Base Specification Revision 4.0, Version 1.0, which is incorporated herein by reference.

A PCIe link between two devices may consist of one or more lanes. For example, a PCIe link may have one lane (×1), 4 lanes (×4), eight lanes (×8), twelve lanes (×12), sixteen lanes (×16), and thirty-two lanes (×32). A link can have a higher bandwidth by using more lanes. However, using more lanes per PCIe link increases power consumption.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide systems and methods for dynamic serial data link (e.g., Peripheral Component Interconnect Express) reconfiguration to optimize power consumption of the serial data link. In some embodiments, Peripheral Component Interconnect Express (PCIe) link reconfiguration may be based on power state based transition, utilization based transition, and/or host based transition.

One aspect of the disclosure provides a method of operating a first device using a serial data link including one or more lanes. In one example, the serial data link may be a Peripheral Component Interconnect Express (PCIe) link. The first device communicates data with a second device using the serial data link configurable to operate in a plurality of link configurations. Each link configuration includes a lane width and a technology generation. The technology generation defines a set of rules for operating the serial data link. The first device detects a condition for changing the link configuration of the serial data link. Then, the first device may select a link configuration among the plurality of link configurations that prioritizes reduction of the lane width over downgrading the technology generation to meet a predetermined performance requirement of the serial data link. After selecting the link configuration, the first device modifies the serial data link to use the selected link configuration.

Another aspect of the disclosure provides an apparatus configured to communicate with a host using a serial data link including one or more lanes. In one example, the serial data link may be a PCIe link. The apparatus has a communication interface configured to communicate data with the host using the serial data link configurable to operate in a plurality of link configurations. Each link configuration includes a lane width and a technology generation. The technology generation defines a set of rules for operating the serial data link. The apparatus has a controller operatively coupled with the communication interface. The controller is configured to detect a condition for changing the link configuration of the serial data link. The controller selects a link configuration among the plurality of link configurations that prioritizes reduction of the lane width over downgrading the technology generation to meet a predetermined performance requirement of the serial data link. Then, the control modifies the serial data link to use the selected link configuration.

Another aspect of the disclosure provides an apparatus configured to communicate with a host using a serial data link comprising one or more lanes. The apparatus includes means for communicating data with a second device using the serial data link configurable to operate in a plurality of link configurations. Each link configuration includes a lane width and a technology generation, and the technology generation defines a set of rules for operating the serial data link. The apparatus further includes means for detecting a condition for changing the link configuration of the serial data link. The apparatus further includes means for selecting a link configuration among the plurality of link configurations that prioritizes reduction of the lane width over downgrading the technology generation to meet a predetermined performance requirement of the serial data link. The apparatus further includes means for modifying the serial data link to use the selected link configuration.

### BRIEF DESCRIPTION OF THE DRAWINGS

FIG. 1 is a block diagram illustrating two devices connected by a Peripheral Component Interconnect Express (PCIe) link in accordance with some embodiments.

FIG. 2. is a diagram illustrating a computing system that uses a PCIe link between a host and a solid state device (SSD) in accordance with some embodiments of the disclosure.

FIG. 3 is a diagram illustrating some PCIe link states in accordance with some embodiments.

FIG. 4 is a flow chart illustrating a method for reconfiguring a serial data link in accordance with some embodiments.

FIG. 5 is a flow chart illustrating a method for determining a power state condition of a device in accordance with some embodiments.

FIG. 6 is a table illustrating some exemplary power states and related parameters.

FIG. 7 is a flow chart illustrating a method for reconfiguring a serial data link based on utilization in accordance with some embodiments.

FIG. 8 is a flow chart illustrating a method for reconfiguring a serial data link using host based transitions in accordance with some embodiments

### DETAILED DESCRIPTION

Referring now to the drawings, systems and methods for reconfiguring a Component Interconnect Express (PCIe) link to dynamically manage PCIe bandwidth to optimize power consumption and reduce underutilized bandwidth.

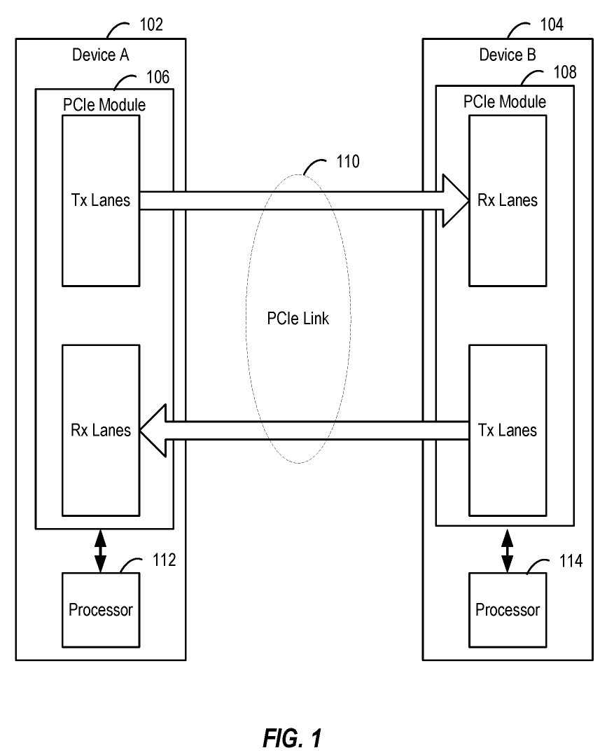

FIG. 1 is a block diagram illustrating two devices connected by a PCIe link in accordance with some embodiments. PCIe is an industry standard managed by the Peripheral Component Interconnect Special Interest Group (PCI-SIG). PCIe provides a point-to-point serial link between two devices for data communication. For example, a first device 102 (device A) can communicate with a second device 104 (device B) via a PCIe link connected to their respective PCIe modules 106 and 108. The devices may be computers, peripheral devices, data storage, and/or any devices that can use a PCIe link for data communication. In one particular example, device A may be a host computer, and device B may be a solid state drive (SSD). A PCIe link 110 supports a point-to-point communication channel between the two devices using one or more lanes, with each lane providing bi-directional data communication.

The PCIe link 110 can include one or more lanes for transmitting and receiving data between the devices. Each lane includes a set of differential signal pairs, one pair for transmission and one pair for reception. A ×N Link (e.g., ×1, ×2, ×4, ×8, ×16) is composed of N lanes. For example, an ×1 PCIe link includes one lane, and an ×16 PCIe link includes 16 lanes. When a PCIe link 110 includes multiple lanes, the bandwidth of the individual lanes are aggregated to provide more bandwidth. During hardware initialization, device A and device B negotiate the lane widths and frequency of operation used by the PCIe link. In general, the frequency of operation of the PCIe link increases in later PCIe generations, resulting in higher data rate per-lane. However, using more lanes and/or higher frequency (i.e., newer generation) increases power consumption by the devices. Each newer PCIe generation generally uses higher frequency to increase data rate of the PCIe link. PCIe generations may be referred to as technology generation in this disclosure.

Table 1 below illustrates data rates (GB/s) of some exemplary PCIe lane and technology generation combinations.

TABLE 1

| Lanes | Gen4 | Gen3 | Gen2 | Gen1 |
|---|---|---|---|---|
| 4 | 6.4 | 3.2 | 1.28 | 0.64 |
| 2 | 3.2 | 1.6 | 0.64 | 0.32 |
| 1 | 1.6 | 0.8 | 0.32 | 0.16 |

Table 2 below illustrates power consumption (Watts) of some exemplary PCIe lane and technology generation combinations.

TABLE 2

| Lanes | Gen4 | Gen3 | Gen2 | Gen1 |
|---|---|---|---|---|
| 4 | 0.54 | 0.37 | 0.33 | 0.28 |
| 2 | 0.28 | 0.2 | 0.18 | 0.15 |
| 1 | 0.15 | 0.11 | 0.1 | 0.09 |

In some embodiments, device A and device B each include one or more processors 112 and 114 to control various operations including PCIe operations and data communication between the devices. The processors 112 and 114 may be implemented as any type of processing devices, such as microprocessors, microcontrollers, embedded controllers, logic circuits, software, firmware, or the like, for controlling the operation of the devices 102 and 104. In one embodiment, the processors 112 and 114 can be special purpose controllers specifically configured/programmed to perform any of the functions and procedures contained within the application.

In some embodiments, some or all of the functions, processes, and procedures described herein as being performed by the processors 112 and 114 may instead be performed by one or more elements of the devices 102 and 104. For example, each device 102 or 104 may include a microprocessor, a microcontroller, an embedded controller, a logic circuit, a field-programmable gate array (FPGA), an application-specific integrated circuit (ASIC), software, firmware, or any kind of processing device, for performing one or more of the functions described herein as being performed by the processors 112/114 and/or PCIe modules 106/108.

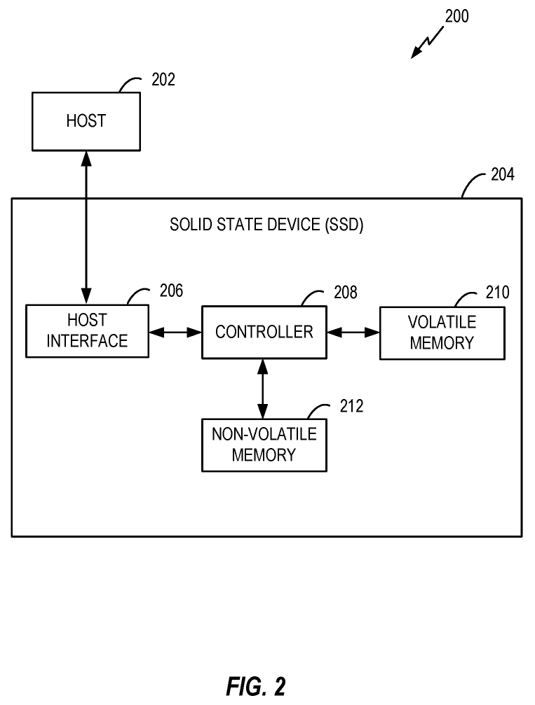

FIG. 2 is a block diagram illustrating a computing system 200 in accordance with some embodiments of the disclosure. The system 200 includes a host 202 and a solid state device (SSD) 204 coupled to the host 202. In one example, the host 202 may be the same as the device A 102, and the SSD 204 may be the same as the device B 104. The host 202 provides various commands to the SSD 104 for transferring data between the host 202 and the SSD 204. For example, the host 202 may provide a write command to the SSD 204 for writing or programming data to the SSD 204, or a read command to the SSD 204 for reading or retrieving data from the SSD 204. The host 202 may be any system or device having a need for data storage or retrieval and a compatible interface for communicating with the SSD 204. For example, the host 202 may a computing device, a personal computer, a portable computer, a workstation, a server, a personal digital assistant, a digital camera, a digital phone, or the like. In some embodiments, the SSD 204 includes a host interface 206, a controller 208, a volatile memory 210, and a non-volatile memory (NVM) 212. In one embodiment, the connection between the host 202 and the host interface 206 may be a PCIe link.

### PCIe Link States

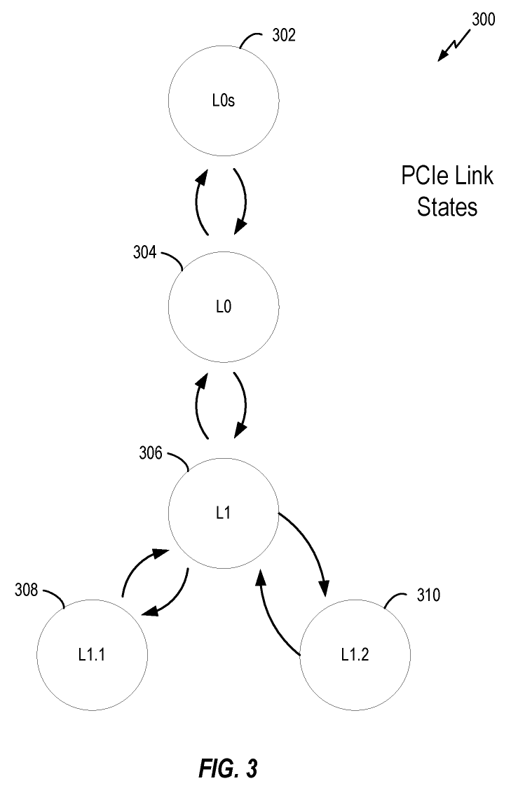

PCIe standards define various link power management states that can be called link states in short. FIG. 3 is a diagram illustrating some PCIe link states in accordance with some embodiments of the disclosure. During PCIe operations, the devices 102 and 104 may transition among different link states including, for example, link states L0, L0s, L1, L1.1, L1.2, L2, and L3. In some embodiments, one or more of these link states may not be implemented in device A and/or B. Link state L0 304 is the only active state in which data can be communicated between device A and device B via the PCIe link 110. In general, after different periods of link idle, a device can transition from the active link state L0 to one of the power saving link states (e.g., L0s, L1, L1.2, etc.). The power saving link states are different in the amount of power saving and latency they provide before returning to the fully functional state L0.

For example, link state L0s 302 is a low latency energy saving standby state. In this link state, no data can be communicated on the PCIe link, and some circuit components of the device can be disabled or turned off to reduce power consumption. The transition time from L0s back to L0 is typically the shortest among all the power saving link states. The time needed to transition out of a power saving link state (e.g. L0s) is called the exit latency. Link state L0s can be used to reduce power wastage during short intervals of idle between PCIe link activities.

Power saving link state L1 306 has higher exit latency than the L0s link state. For example, link state L1 306 may be used to reduce power when the device becomes aware of a lack of outstanding PCIe requests or pending transactions. Link state L1 provides more power saving than link state L0s at the expense of higher exit latency. In link state L1, a device can turn off its transmitter and enters an electrical idle state. When returning from L1 to L0, both devices may go through a link recovery process to retrain the PCIe link to reestablish synchronization.

Link state L1 may optionally include substates, for example, link substate L1.1 and link substate L1.2. Substate L1.1 (308) may be used as a low power link state in Peripheral Components Interface Power Management (PCIPM), and substate L1.2 (310) may be used as a low power link state in Active State Power Management (ASPM). In the L1.1 substate, the link common mode voltages are maintained. In the L1.2 substate, the link common mode voltages may not be maintained. The L1.2 substate is entered when the PCIe link is in the L1 substate and conditions for entry into L1.2 substate are met.

For example, the devices A and B may enter a power saving PCIe link state after certain predetermined conditions are met including a timeout when the PCIe link is idle (i.e., no data communication between devices). In general, the low power saving link state (e.g., L0s) has a shorter timeout than the high power saving link state (e.g., L1.2).

Aspects of the present disclosure provide various dynamic PCIe link reconfiguration methods to optimize power consumption of a PCIe link. In some embodiments, PCIe link reconfiguration may be based on power state based transition, utilization based transition, and/or host based transition. These different approaches are described in more detail below in turn. To avoid unnecessary power consumption, a PCIe link is dynamically set in a minimum configuration that can support an input-output (I/O) requirement. A PCIe configuration includes the number of lanes used and technology generation. A minimum PCIe configuration refers to a certain combination of lanes and technology generation that can support the corresponding I/O requirement (e.g., data rate) without substantial underutilized bandwidth.

As illustrated in Tables 1 and 2, reducing lane number results in more power saving than moving to a lower PCIe generation, for the same data rate reduction. Therefore, it will be more effective to save power by prioritizing lane number reduction when transitioning between different PCIe configurations.

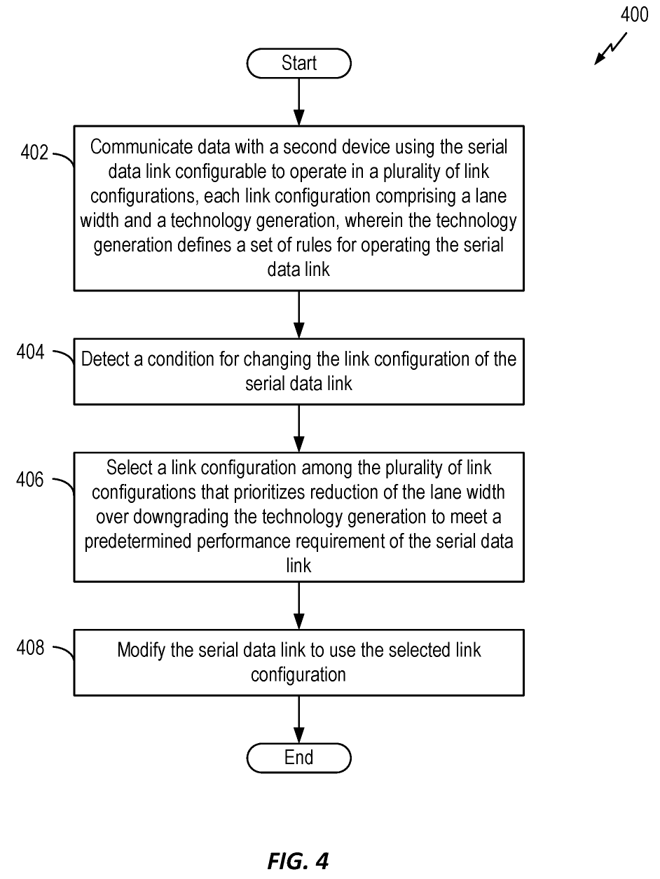

FIG. 4 is a flow chart illustrating a method 400 for operating a serial data link in accordance with some embodiments. In one example, this method 400 may be performed by the device A 102 or device B 104 to dynamically manage the power consumption of the PCIe link 110 that is a serial data link. In some embodiments, the method 400 may be performed by any device to reconfigure a PCIe link for power management.

At block 402, a first device may communicate data with a second device using a serial data link configurable to operate in a plurality of link configurations. Each link configuration includes a lane width and a technology generation. For example, the lane width may be ×1, ×2, ×4, ×8, or ×16 of a PCIe link. The technology generation defines a set of rules for operating the serial data link. For example, a technology generation may refer to the PCIe version or generation such as 1^{st}, 2^{nd}, 3^{rd}, or 4^{th} PCIe generation.

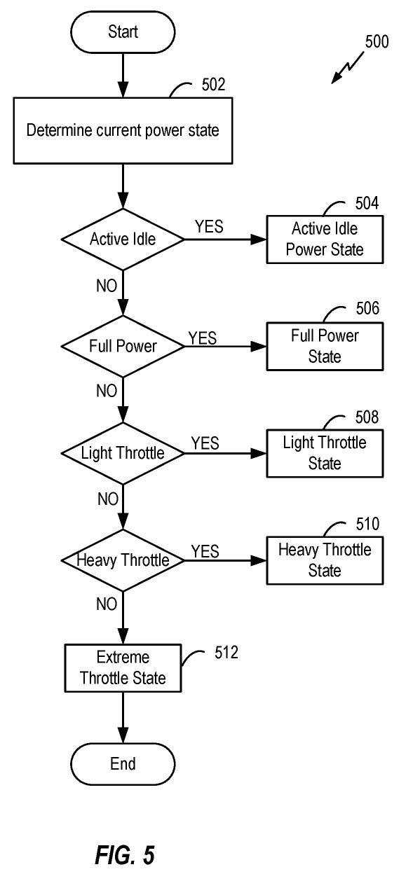

At block 404, the first device detects a condition for changing the link configuration of the serial data link. For example, the device may determine the condition based on whether the current PCIe configuration (e.g., lane width and technology generation) can meet the power consumption, performance (e.g., data transfer rate), and/or link utilization requirement of the serial data link. In some embodiments, the device may use a power state based method, utilization based method, and/or host based method to determine the condition. These methods will be described in more detail in relation to FIGS. 5-8.

At block 406, the device selects a link configuration among the plurality of link configurations that prioritizes reduction of the lane width over downgrading the technology generation to meet a predetermined performance requirement of the serial data link. In some embodiments, the performance requirement may include data rate (bandwidth) and/or power consumption. In some examples, reducing lane width or downgrading technology generation can reduce power consumption as illustrated in Table 2. However, lane width reduction generally results in more saving in power consumption than downgrading technology generation. Therefore, the device, in block 406, may prioritize lane width reduction over technology generation downgrade.

At block 408, the device modifies the serial data link to use the selected link configuration. In some examples, the first device and second device may communicate with each other according to a PCIe handshake protocol, and both devices support dynamic reconfiguration of PCIe link states and technology generations. The transmitter (first device or second device) may send a request over the serial data link to initiate reconfiguration to the selected link configuration.

### Power State Based Transition

FIG. 5 illustrates a flow chart illustrating a method 500 for determining a power state condition of a device in accordance with some embodiments. In some examples, the method 500 may be used by a device in block 404 of FIG. 4 to determine a reconfiguration condition of a PCIe link based on the device's current power state. At block 502, the device determines a current power state. Some exemplary power states are active-idle state 504, full power state 506, light throttling state 508, heavy throttling state 510, and extreme throttling state 512. In any of the throttling states, the device needs to reduce its power consumption, for example, by reducing the data rate of the PCIe link.

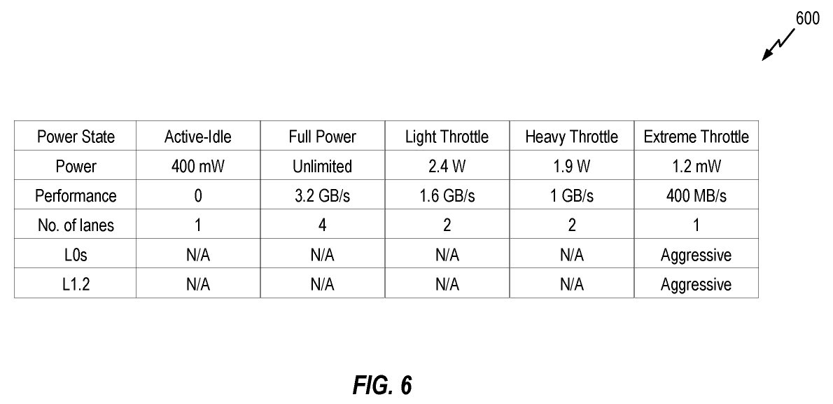

FIG. 6 is a table 600 illustrating some exemplary power states and related parameters. In the active-idle power state 504, the device is not transferring data and may have a power consumption limit of 400 milliwatts (mW). In the full power state 506, the device has no power consumption limit and a date rate of 3.2 GB/s. In the light throttling power state 508, the device has a power consumption limit of 2.4 Watts (W) and a date rate of 1.6 GB/s. In the heavy throttling power state 510, the device has a power consumption limit of 1.9 W and a date rate of 1 GB/s. In the extreme throttling power state 512, the device has a power consumption limit of 1.2 W and a date rate of 400 MB/s. The power consumption and performance (e.g., data rate) values shown in table 600 are illustrative in nature. In other embodiments, the power states may have different parameters and/or values.

In one example, it is assumed that the device is initially configured in a link configuration that has a lane width of 4 using 4^{th} generation PCIe. If the device is in the active idle power state 404, the device has no bandwidth requirement. In that case, the device can reconfigure the PCIe link 110 to use a ×1 configuration without downgrading the technology generation. As the example shown in table 2, power consumption can be reduced from 0.54 W to 0.15 W that is less than the 400 mW limit of the active idle power state.

If the device is now in the full power state 506, the device has a bandwidth requirement of 3.2 GB/s. In that case, the device can reconfigure the PCIe link 110 to maintain a lane width of 4 but downgrading to 3^{rd} generation PCIe. As the example shown in table 2, power consumption can be reduced from 0.54 W to 0.37 W while still meeting the bandwidth requirement of the full power state 506.

If the device is now in the light throttling power state 506, the device has a bandwidth requirement of 1.6 GB/s. In that case, the device can reconfigure the PCIe link 110 to use a lane width of 2 and downgrade to 3rd generation PCIe. As the example shown in table 2, power consumption can be reduced from 0.54 W to 0.2 W.

If the device is now in the heavy throttling power state 508, the device has a bandwidth requirement of 1 GB/s. In that case, the device can reconfigure the PCIe link 110 to use a lane width of 2 and downgrade to 3rd generation PCIe. This configuration can support a bandwidth of 1.6 GB/s. As the example shown in table 2, power consumption can be reduced from 0.54 W to 0.2 W. In another example, the device can reconfigure the PCIe link 110 to use a lane width of 1 and continue to use 4th generation PCIe. This configuration also supports a bandwidth of 1.6 GB/s. As the example shown in table 2, power consumption can be reduced from 0.54 W to 0.15 W. In this case, reducing lane width can achieve more power consumption reduction than downgrading technology generation.

If the device is now in the extreme throttling power state 510, the device has a bandwidth requirement of 400 MB/s. In that case, the device can reconfigure the PCIe link 110 to use a lane width of 1 and continue to use 4rd generation PCIe. This configuration can support a bandwidth of 1.6 GB/s. As the example shown in table 2, power consumption can be reduced from 0.54 W to 0.15 W. Further power consumption reduction may be made by downgrading technology generation, however, with diminishing results.

In some embodiments, the device may use more aggressive PCIe link state timeout in the extreme throttling power state. In some embodiments, the device may reduce the timeout values of some PCIe power saving link states (e.g., L0s and/or L1.2). In one example, PCIe link state L0s may have a default timeout of about 30 μs and an aggressive timeout of about 1 μs. In one example, PCIe link state L1.2 may have a default timeout of about 100 milliseconds (ms) and an aggressive timeout of about 1 ms. A shorter timeout allows faster transition to the energy saving link state. The device may dynamically change the timeout values based on the current power state of the device.

The above described PCIe reconfiguration examples prioritize lane width reduction over technology generation downgrade because power reduction is more significant when reducing lane width than downgrading PCIe generation, for example, as shown in Table 2. In some embodiments, the power state based PCIe link reconfiguration techniques described above may be performed with the technology generation fixed, for example, to the 3^{rd} generation.

### Utilization Based Transition

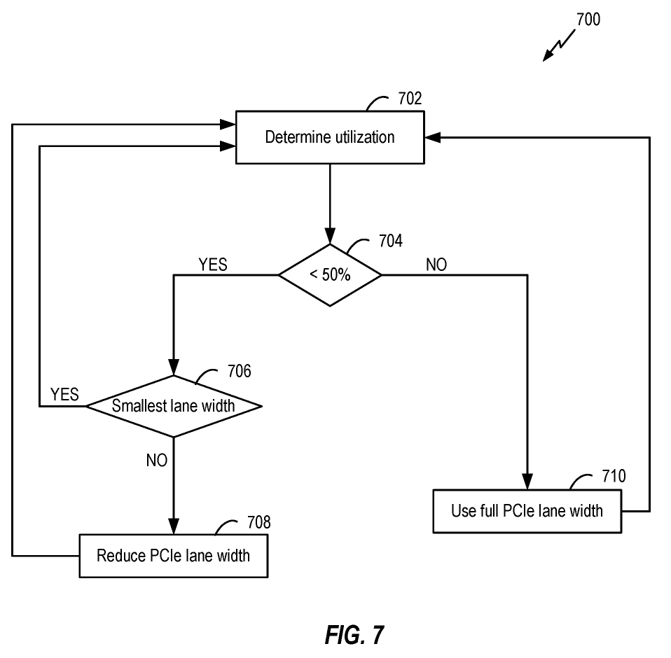

FIG. 7 illustrates a flow chart illustrating a method 700 for reconfiguring a serial data link based on utilization of the link in accordance with some embodiments. In some examples, the method 700 may be used by a device to reconfigure a PCIe link based on the device's current utilization of the link. In some embodiments, the device may be the device A 102 or device B 104, and the serial data link may be the PCIe link 110.

At block 702, the device determines the utilization of the PCIe link 110. The device may collect front end utilization statistics, for example, bytes transferred over the PCIe link to determine a link utilization percentage per time window. For example, if X bytes are transferred over the PCIe link over a period of time T, the transfer rate is R=X/T. The PCIe utilization may be determined R divided by the PCIe link's rated bandwidth. Some examples of PCIe rated bandwidths are shown in Table 1.

At decision block 704, the device determines whether or not link utilization is smaller than 50%. If the utilization is smaller than 50%, the device further determines whether or not the current lane width is the smallest lane width at decision block 706. For example, PCIe link may have a smallest lane width of one (e.g., ×1). At block 708, if the current lane width is not the smallest lane width, the device reduces the lane width to the next lower lane width while not changing the PCIe generation. For example, if the PCIe link is currently configured to have a lane width of 4 using 4^{th} generation PCIe, the device may reconfigure the PCIe link to have a lane width of 2 and continue to use 4^{th} generation PCIe. In this case, according to Table 2, the device can reduce power consumption from 0.54 W to 0.15 W. Similarly, if the PCIe link is currently configured to have a lane width of 2 using 4^{th} generation PCIe, the device may reconfigure the PCIe link to have a lane width of 1 and continue to use 4^{th} generation PCIe. Other examples are possible.

At block 710, if the utilization is greater than 50%, the device increases the lane width of the PCIe link 110 to its largest supported lane width (e.g., ×4). For example, if the PCIe link is currently configured to have a lane width of 1 or 2 using 4^{th} generation PCIe, the device may reconfigure the PCIe link to have a lane width of 4 (largest supported lane width of the device) and continue to use 4^{th} generation PCIe. The device may repeat the above described procedures of method 700 to dynamically reconfigure the PCIe link based on the utilization of the link.

### Host Based Transition

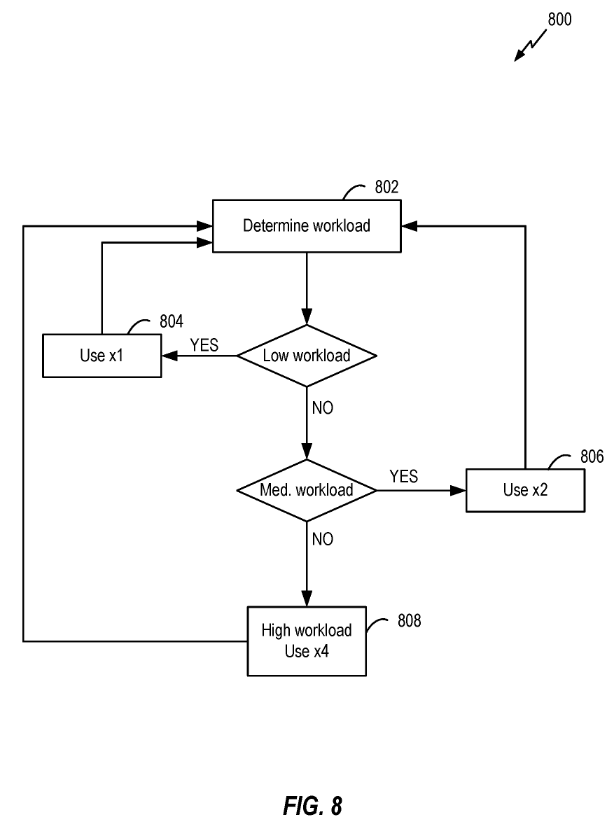

FIG. 8 is a flow chart illustrating a method 800 for reconfiguring a serial data link using host based workload transitions in accordance with some embodiments. In some examples, the method 800 may be used by a host device to proactively reconfigure a PCIe link based on a host device's expected workload intensity of a serial data link. In some embodiments, the host device may be the device A 102 or device B 104, and the serial data link may be the PCIe link 110.

At block 802, the host device determines an expected workload intensity of the PCIe link. The host device may determine the workload based on various factors such as command queue utilization of the PCIe link. In some examples, the host device may receive certain information that may be used to determine the expected workload from an application running on the host device. In one example, the application may indicate that autosave is performed every minute. In that case, the host device may determine the expected PCIe workload or traffic generated by the autosave function based on, for example, statistic collected on previous autosave traffic of the application. In one example, the host device can sense user activity and determine that the host has been idle for a while so that the host may reduce lane width in response to the reduced PCIe workload. When the host device senses that the user resumed work, the host device can transition to a full lane width configuration. In another example, the host device can identify that a user is opening an application that is known for high (or low) PCI bandwidth requirement.

At block 804, if the expected workload is low (e.g., smaller than 25% link bandwidth), the device may reconfigure the PCIe link to a lane width of ×1. At block 806, if the expected workload is medium (e.g., between 25% and 50% link bandwidth), the device may reconfigure the PCIe link to a lane width of ×2. At block 808, if the expected workload is high (e.g., greater than 50% link bandwidth), the device may reconfigure the PCIe link to a lane width of ×4. The lane widths and workload levels described above in relation to FIG. 8 are illustrative only. In other embodiments, the method 800 may use other workload levels to determine various lane widths to be used in different configurations.

In some embodiments, the host device may initiate the lane width change itself based on the expected workload intensity, or the other device connected to the PCIe link may initiate the lane width change based on information (e.g., expected workload) received from the host device.

The above described PCIe reconfiguration methods may be used individually or in any combinations including one or more of the methods and procedures described in relation to FIGS. 1-8.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner Tasks or events may be added to or removed from the disclosed example embodiments. The example systems and components described herein may be configured differently than described. For example, elements may be added to, removed from, or rearranged compared to the disclosed example embodiments.

1. A method of operating a first device using a serial data link comprising one or more lanes, comprising:
communicating data with a second device using the serial data link configurable to operate in a plurality of link configurations, each link configuration comprising a lane width and a technology generation, wherein the technology generation defines a set of rules for operating the serial data link;
detecting a condition for changing the link configuration of the serial data link, the condition comprising a current power state among a plurality of power states of the first device wherein the plurality of power states comprise a full power state and one or more throttled power states, each of the power states comprising a power consumption limit;
reducing, if the current power state is one of the throttled power states, a timeout duration for transitioning the serial data link to a power saving link state;
selecting, in response to detecting the condition, a link configuration among the plurality of link configurations that prioritizes reduction of the lane width over downgrading the technology generation to meet a predetermined performance requirement of the serial data link; and
modifying the serial data link to use the selected link configuration.

2. (canceled)

3. The method of claim 1, wherein the selecting the link configuration comprises:
selecting a lane width and a technology generation combination that provides a bandwidth sufficient to meet the predetermined performance requirement.

4. (canceled)

5. The method of claim 1, wherein the serial data link comprises a Peripheral Component Interconnect Express (PCIe) link.

6. The method of claim 1, wherein the detecting the condition comprises:
determining a utilization rate of the serial data link.

7. The method of claim 6, wherein the selecting the link configuration comprises:
if the utilization rate is less than a predetermined value, selecting a link configuration to decrease the lane width of the serial data link; and
if the utilization rate is greater than the predetermined value, selecting a link configuration to increase the lane width of the serial data link.

8. The method of claim 1, wherein the detecting the condition comprises:
determining an expected workload of the serial data link.

9. The method of claim 8, wherein the selecting the link configuration comprises:
if the expected workload is less than a predetermined value, selecting a link configuration to decrease the lane width of the serial data link; and
if the expected workload is greater than a predetermined value, selecting a link configuration to increase the lane width of the serial data link.

10. An apparatus configured to communicate with a host using a serial data link comprising one or more lanes, comprising:
a communication interface configured to communicate data with the host using the serial data link configurable to operate in a plurality of link configurations, each link configuration comprising a lane width and a technology generation, wherein the technology generation defines a set of rules for operating the serial data link;
a controller operatively coupled with the communication interface, wherein the controller is configured to:
detect a condition for changing the link configuration of the serial data link, the condition comprising a current power state among a plurality of power states of the apparatus, wherein the plurality of power states comprise a full power state and one or more throttled power states, each of the power states comprising a power consumption limit;
reduce, if the current power state is one of the throttled power states, a timeout duration for transitioning the serial data link to a power saving link state;
select, in response to detecting the condition, a link configuration among the plurality of link configurations that prioritizes reduction of the lane width over downgrading the technology generation to meet a predetermined performance requirement of the serial data link; and
modify the serial data link to use the selected link configuration.

11. (canceled)

12. The apparatus of claim 10, wherein the controller is further configured to select the link configuration by:
selecting a lane width and a technology generation combination that provides a bandwidth sufficient to meet the predetermined performance requirement.

13. (canceled)

14. The apparatus of claim 10, wherein the serial data link comprises a Peripheral Component Interconnect Express (PCIe) link.

15. The apparatus of claim 10, wherein the controller is further configured to detect the condition by:
determining a utilization rate of the serial data link.

16. The apparatus of claim 15, wherein the controller is further configured to select the link configuration by:
if the utilization rate is less than a predetermined value, selecting a link configuration to decrease the lane width of the serial data link; and
if the utilization rate is greater than the predetermined value, selecting a link configuration to increase the lane width of the serial data link.

17. The apparatus of claim 10, wherein the controller is further configured to detect the condition by:
determining an expected workload of the serial data link.

18. The apparatus of claim 17, wherein the controller is further configured to select the link configuration by:
if the expected workload is less than a predetermined value, selecting a link configuration to decrease the lane width of the serial data link; and
if the expected workload is greater than a predetermined value, selecting a link configuration to increase the lane width of the serial data link.

19. An apparatus configured to communicate with a host using a serial data link comprising one or more lanes, comprising:
means for communicating data with a second device using the serial data link configurable to operate in a plurality of link configurations, each link configuration comprising a lane width and a technology generation, wherein the technology generation defines a set of rules for operating the serial data link;
means for detecting a condition for changing the link configuration of the serial data link, the condition comprising a current power state among a plurality of power states of the apparatus, wherein the plurality of power states comprise a full power state and one or more throttled power states, each of the power states comprising a power consumption limit;
means for reducing, if the current power state is one of the throttled power states, a timeout duration for transitioning the serial data link to a power saving link state;
means for selecting, in response to detecting the condition, a link configuration among the plurality of link configurations that prioritizes reduction of the lane width over downgrading the technology generation to meet a predetermined performance requirement of the serial data link; and
means for modifying the serial data link to use the selected link configuration.

20. The apparatus of claim 19, wherein the means for detecting the condition is further configured to, at least one of:
determine a utilization rate of the serial data link; or
determine an expected workload of the serial data link.

21. The method of claim 1, wherein the throttled power states have different power consumption limits.

22. The apparatus of claim 10, wherein the throttled power states have different power consumption limits.
